(19) United States
(12) Patent Application Publication
(10) Pub. No.: US 2014/0147722 A1
(43) Pub. Date: May 29, 2014

(54) CONNECTION ASSEMBLY FOR CELLS IN A BATTERY

(71) Applicant: SUPER B B.V., Hengelo (Ov) (NL)

(72) Inventors: Marinus Hendrikus Doornpekamp, Hengelo (Ov) (NL); Marten, Johan Zilvold, Hengelo (Ov) (NL)

(73) Assignee: SUPER B.B.V, Hengelo (Ov) (NL)

(21) Appl. No.: 14/118,668

(22) PCT Filed: May 19, 2011
(86) PCT No.: PCT/NL2011/050345

§ 371 Date: Jan. 17, 2014

(51) Int. Cl. H01M 2/20; H01M 2/22

(52) U.S. Cl. CPC H01M 2/204; H01M 2/206; H01M 2/22
USPC 429/121; 29/623.1

(57) ABSTRACT

Connection assembly for connecting two or more cells (10) in a battery pack. The connection assembly (1) has a first connector element (2) of a first material and a second connector element (3) of a second material. The first material has a lower resistivity than the second material. The first connector element (2) and second connector element (3) are electrically connected to each other by a low resistance connection (5).

### FIELD OF THE INVENTION

The present invention relates to a connection assembly for connecting two or more cells in a battery pack. In a further aspect, a method is provided for manufacturing a battery pack comprising two or more cells.

### PRIOR ART

Battery packs comprising a plurality of cells are used in a wide variety of applications. In known battery packs, usually connection elements of strip like Nickel material are used to interconnect cells, as this material can be connected to the cell materials (steel or aluminum) without problems relating to safety.

### SUMMARY OF THE INVENTION

The present invention seeks to provide an improved connection assembly for cells in a battery pack, which improves the characterizing parameters of a battery pack, such as internal resistance.

According to the present invention, a connection assembly according to the preamble defined above is provided, wherein the connection assembly comprises a first connector element of a first material and a second connector element of a second material, the first material having a lower resistivity than the second material, the first connector element and second connector element being electrically connected to each other by a low resistance connection. A battery pack using such a connection assembly can then be provided having a very low internal resistance, which improves performance of the battery pack.

According to a further aspect of the present invention a method as defined above is provided, wherein the method comprises providing a first connector element, providing at least one second connector element, the second connector element being provided with an aperture, first connecting the first connector element to the at least one second connector elements using a low resistance connection technique, and then connecting the apertures of the at least one second connector element to the two or more cells of the battery pack. The right materials for the various elements can be used for allowing easy and safe assembly of the entire battery pack, and simultaneously provide a battery pack having a very low internal resistance.

### SHORT DESCRIPTION OF DRAWINGS

The present invention will be discussed in more detail below, using a number of exemplary embodiments, with reference to the attached drawings, in which

FIG. 1 shows a perspective top view of a first embodiment of a connection assembly according to the present invention;

FIG. 2 shows a perspective bottom view of the connection assembly of the embodiment of FIG. 1 with connected cells;

FIG. 3 shows a perspective top view of a second embodiment of a connection assembly according to the present invention;

FIG. 4 shows a perspective bottom view of the connection assembly of the embodiment of FIG. 3 with connected cells;

FIG. 5 shows a perspective top view of a third embodiment of a connection assembly according to the present invention;

FIG. 6 shows a perspective bottom view of the connection assembly of the embodiment of FIG. 5 with connected cells.

### DETAILED DESCRIPTION OF EXEMPLARY EMBODIMENTS

Battery packs comprising a plurality of cells are more and more being used in all sorts of applications. The cells of a battery pack need to be connected to each other (in parallel or in series, or combinations of both) using a material with as low a resistivity as possible, in order to obtain as low as possible internal losses. The cells of modern type of batteries are e.g. Lithium based cells, such as Lithium Ion cells, Lithium Ion Polymer cells, LiFePO₄ cells, etc. These cells can deliver high currents (in the order of more than 100 A) as a result of which internal losses can be substantial. The cells are usually provided with a casing of steel or aluminum to which the connecting material is electrically connected, using a variety of techniques such as (resistance) welding, soldering, gluing, bonding, etc.

The material of a cell casing and the materials used inside the cell pose strict requirements of possible connection techniques. The lithium material of the cells should be kept to below 60°. For connecting the cells, e.g. Ag or Cu material cannot be welded onto the casing as this involves too high a temperature. Due to the low resistance, resistance welding is mostly not possible, the welding currents would possibly flow into the cells and thus not heat the material. Laser welding changes the structure of the material, often resulting in semiconductor types of crystallization structures, which is also an unwanted effect in battery packs.

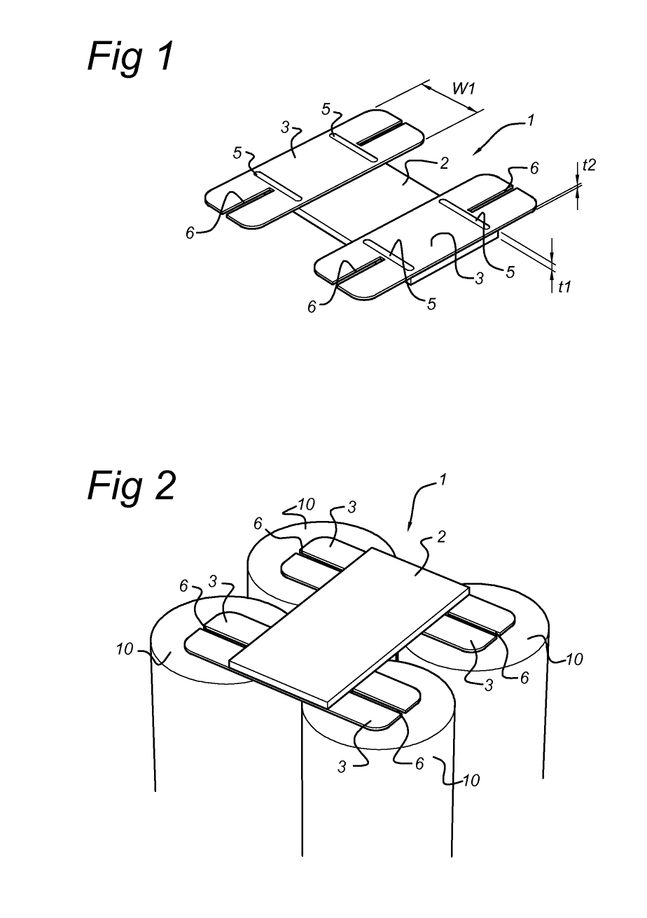

In FIG. 1 a perspective top view is shown of a first embodiment of a connection assembly 1 according to the present invention, which can be used to electrically connect cells of a battery pack, in this case for connection four cells. FIG. 2 shows a perspective bottom view of the connection assembly 1 of FIG. 1, wherein four cells 10 are also shown partially in a cylindrical embodiment which can be used to form a complete four cell battery pack.

The connection assembly 1 comprises a first connector element 2 of a first material and, in the embodiment shown, two second connector elements 3 of a second material, the first material having a lower resistivity than the second material. The first connector element 2 and second connector elements 3 are electrically connected to each other by low resistance connections 5, as shown in the top view of FIG. 1. The first material is a low resistivity material, e.g. Cu or Ag (or mixtures thereof). Copper (Cu) has a resistivity of 1.68×10⁻⁸ Ωm. Other suitable first materials are e.g. Aluminum (2.65×10⁻⁸ Ωm), Silver (1.59×10⁻⁸ Ωm), Gold (2.2×10⁻⁸ Ωm)| The second material is a material which can be electrically connected to a cell in a battery pack using modest temperature bonding techniques, such as Ni. Nickel (Ni) has a resistivity of 13.5×10⁻⁸ Ωm, allowing resistive welding techniques. Other materials which are suitable for welding (second material) are e.g. Ni201 (9.5×10⁻⁸ Ωm), Iron (9.7×10⁻⁸ Ωm), Brass (7.2×10⁻⁸ Ωm) and Tungsten (5.5×10⁻⁸ Ωm).

The first and second material of the first connector element 2 and (multiple) second connector elements 3 can be electrically connected to each other using e.g. resistance welding or laser welding. Alternative techniques that can be used are gluing or (tin) soldering. Temperatures used for making the electrical connections or weld lines 5 is only limited by the materials used, not by the material of the cells.

The first connection element 2 is used in the connector assembly 1 for providing a low resistance path between two cells in a battery pack. To obtain this, a thickness t₁ (see FIG. 2) of the first connector element 2 is more than 0.1 mm in an embodiment of the present invention, e.g. about 0.4 mm or about 1.0 mm thick.

In an exemplary embodiment, a connection assembly 1 is provided allowing connection of two cells 10. In contrast to the embodiment shown in FIGS. 1 and 2, the first connection element 2 is then only provided between the low resistance connections 5, i.e. with a width similar to the width of second connection element 3. The first connection element 2 e.g. has a length of 40 mm, width of 13 mm and thickness of 0.4 mm, and the weld lines 5 are 24 mm apart. in that case the resistance through the copper part (first connection element 2) between the two weld lines 5 is 0.0000775 ohm, and through the nickel part (second connection element 3) is 0.0006230 ohm.

The second connection element 3 is used in the connector assembly 1 for allowing an electrical connection to be made to the cell material in the battery pack. As battery packs are usually designed to have minimal dimensions, the second connection elements 3 are made as thin as possible. In an exemplary embodiment, a thickness t₂ (see FIG. 2) of the second connector element is less than about 0.4 mm.

The second connector element 3 comprises two or more apertures 6 which allow connecting the second connector element 3 to cells 10 of a battery pack. In the embodiment shown in FIGS. 1 and 2, the apertures 6 have the form of slits, which allow good access to both the second connector element 3 and the cell 10 when e.g. using regular bonding machines, such as. point soldering machines (or alternatively resistance welding, laser welding). In further alternative embodiments, the apertures 6 are provided as holes, rectangles, or more complex shapes. The actual connection of the cell 10 to the second connector element 3 is chosen as close as practically possible to the weld line 5 of the connection assembly, as in that case a short as possible a path through the second material remains.

In order to obtain as low a resistance as possible between two cells connected by a connector assembly 1 according to the present invention, the low resistance connections 5 span substantially across a width w₁ of the second connector element 3 as shown in FIG. 1. In essence a parallel path is formed across the first and second connector elements 2, 3 between the low resistance connections 5. Most (substantially all) of the current between two cells will then flow through the low resistivity material of the first connection element 2 between the low resistance connections 5.

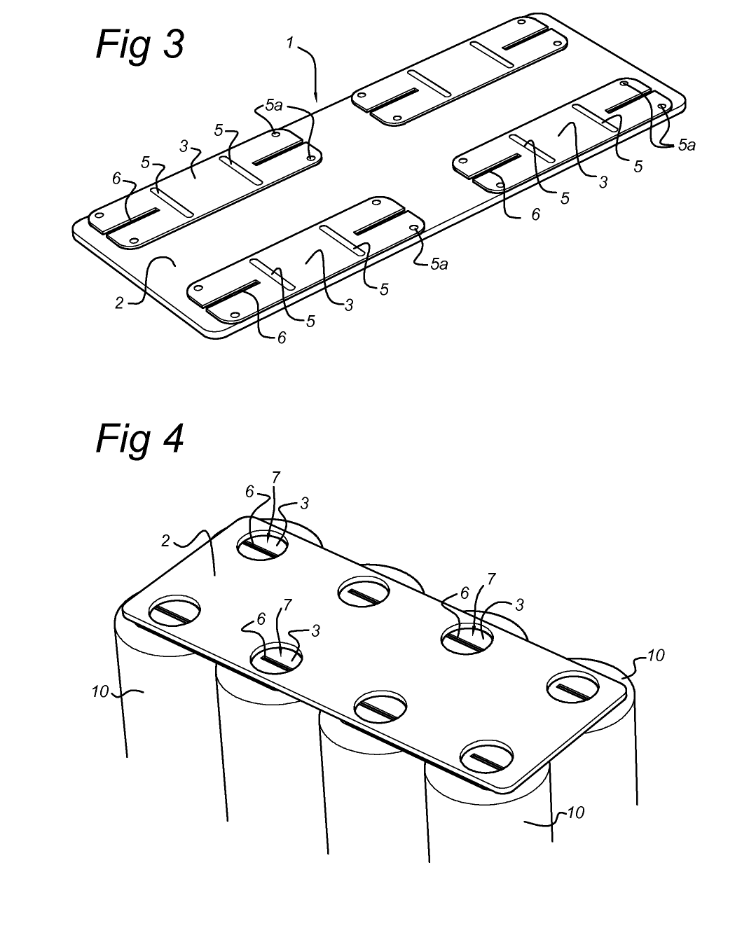

In FIGS. 3 and 4 a top and bottom perspective view are shown, respectively, of a further embodiment of the connection assembly 1 according to the present invention, which allows to provide the parallel connection of eight cells 10 in a battery pack (the cells 10 being partially shown in FIG. 4).

In this embodiment the connection assembly comprises a single first connector element 2 and a plurality (four) of second connector elements 3. Each second connector element 3 is provided with two apertures 6 for connection to two cells. In order to provide a robust and reliable connection assembly 1, the second connector elements 3 are not only electrically connected to the first connection element 1 by the low resistance connection 5, but also further connected using additional connections 5a at extremities of the second connector elements 3.

As visible in the view of FIG. 4, the single first connector element 2 is provided with a number of secondary apertures 7 corresponding to the number of apertures 6 provided in the plurality of second connector elements 3. The secondary apertures 7 allow access to the apertures 6 for welding the second connector elements 3 to the cells 10.

In alternative embodiments, also second connector elements 3 may be used in a substantially square form, allowing connections to be made to four cells 10.

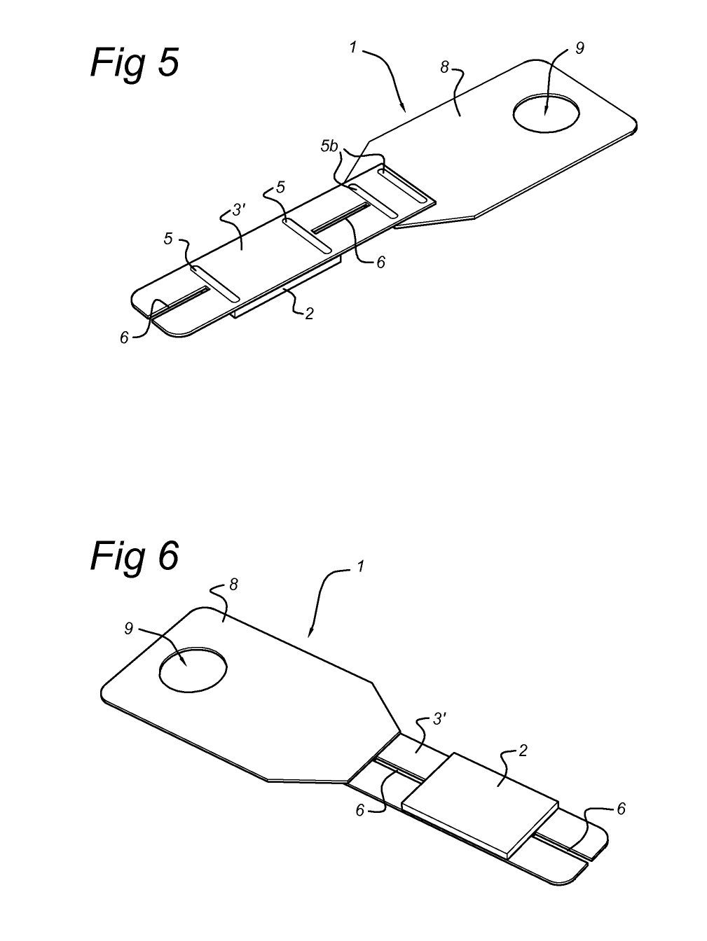

In FIGS. 5 and 6 a top and bottom perspective view are shown, respectively, of an even further embodiment of the connection assembly 1 according to the present invention. This embodiment of the connection assembly allows to interconnect two cells 10 in a battery pack, and simultaneously provide for an external connection of the battery pack. The connection assembly 1 in this embodiment comprises a first connection element 2, connected to a second connection element 3 using low resistivity connections 5, similar to the embodiments of FIGS. 1-2 and 3-4. In addition, the connection assembly 1 comprises an external connection element 8, also made of the first material (i.e. a low resistivity material such as Cu) connected to the second connector element 3 using further low resistivity connections 5b. In the embodiment shown in FIG. 5, two further low resistivity connections 5b are used, which also provide structural rigidity to the connection assembly 1. In the embodiment shown, the external connection element 8 is further provided with a hole 9, which allow for easy external connections, e.g. for soldering a wire to the battery pack.

In an even further embodiment, various embodiments and alternatives of the connection assembly 1 may be used simultaneously. E.g. four cells 10 may be connected in series in a small volume by positioning the cells 10 with opposing pole next to each other. The negative pole of a cell 10 is connected to the positive pole of an adjacent cell 10 using the alternative embodiment of FIG. 1 (two cell embodiment), thus using three connection assemblies 1 for the entire battery pack. For the first and last cell 10, an alternative of the FIGS. 5 and 6 embodiment may be used having only a single cell connection (aperture 6), which provide the external positive and negative contact for the thus formed battery pack with four cells 10. Various battery packs may be assembled using the various embodiments described with reference to the FIGS. 1-6 and alternative embodiments thereof as described herein. E.g. 2 cells 10 may be combined in a series or parallel configuration, but also in combined configuration, e.g. 4 cells is series, and two of such series in parallel, totaling 8 cells 10.

The connector assembly 1 according to the present invention embodiments as described above can be used in the manufacturing of battery packs having a much lower internal resistance than present day battery packs. In a further aspect, the present invention relates to a method for providing a battery pack comprising two or more cells. The method comprises providing a first connector element 2 (e.g. from a blank or sheet of Cu or Ag) and at least one second connector element 3 (e.g. from a blank or sheet of Ni). The second connector element 3 is provided with an aperture 6.

The method further comprises first connecting the first connector element 2 to the at least one second connector element 3 using a low resistance connection technique, thereby forming e.g. the low resistivity connections 5 as shown in the embodiments above. As no cells 10 or other battery pack elements are near at this stage, this connection step can be performed using all known types of connection techniques, including high temperature techniques such as resistance of laser welding. After this step, the method comprises connecting the apertures 6 of the at least one second connector element 3 to the two or more cells 10 of the battery pack. this step is performed using a low temperature connection technique, such as bonding, soldering, welding, fusing, etc. which provides no dangerous situation.

The present invention embodiments have been described above with reference to a number of exemplary embodiments as shown in the drawings. Modifications and alternative implementations of some parts or elements are possible, and are included in the scope of protection as defined in the appended claims.

1-12. (canceled)

13. A connection assembly for connecting two or more cells in a battery pack,
the connection assembly comprising a first connector element of a first material and a second connector element of a second material,
the first material having a lower resistivity than the second material,
the first connector element and second connector element being electrically connected to each other by a low resistance connection, wherein the low resistance connection is a weld line.

14. The connection assembly of claim 13, wherein the first material is selected from the group comprising Ag, Cu, or mixtures thereof.

15. The connection assembly of claim 13, wherein the second material is Ni.

16. The connection assembly of claim 13, wherein a thickness of the first connector element is more than 0.1 mm.

17. The connection assembly of claim 13, wherein a thickness of the second connector element is less than 0.4 mm.

18. The connection assembly of claim 13, wherein the low resistance connection spans substantially across a width of the second connector element.

19. The connection assembly of claim 13, wherein the second connector element comprises two or more apertures.

20. The connection assembly of claim 19, wherein the apertures are slits.

21. The connection assembly of claim 13, comprising a single first connector element and a plurality of second connector elements,
each second connector element being provided with two apertures for connection to two cells.

22. The connection assembly of claim 21, wherein the single first connector element is provided with a number of secondary apertures corresponding to the number of apertures provided in the plurality of second connector elements.

23. The connection assembly of claim 13, further comprising an external connection element, which is electrically connected to the second connector element by a further low resistance connection.

24. Method for providing a battery pack comprising two or more cells, comprising
providing a first connector element,
providing at least one second connector element, the second connector element being provided with an aperture,
first connecting the first connector element to the at least one second connector elements using a low resistance connection technique, using a low resistance connection in the form of a weld line, and
then connecting the apertures of the at least one second connector element to the two or more cells of the battery pack.
